(19) United States
(12) Patent Application Publication
(10) Pub. No.: US 2024/0075490 A1
(43) Pub. Date: Mar. 7, 2024

(54) COATING DEVICE HAVING A TRANSMISSION DEVICE FOR THE WIRELESS TRANSMISSION OF ENERGY AND/OR DATA

(71) Applicant: Dürr Systems AG, Bietigheim-Bissingen (DE)

(72) Inventors: Siegfried Poppe, Unterriexingen (DE); Johannes Höchsmann, Asperg (DE); Martin Keilbach, Oberkessach (DE)

(21) Appl. No.: 18/261,494

(22) PCT Filed: Jan. 17, 2022
(86) PCT No.: PCT/EP2022/050842

§ 371 Date: Jul. 14, 2023

(30) Foreign Application Priority Data
Jan. 19, 2021 (DE) 10 2021 101 026.8

(51) Int. Cl. B05B 13/04; B05B 5/16; B05B 12/00; B25J 11/00; B25J 13/08; B25J 19/00

(52) U.S. Cl. CPC B05B 13/0431; B05B 5/1616; B05B 12/006; B25J 11/0075; B25J 13/08; B25J 19/0045

(57) ABSTRACT

The disclosure relates to a coating device (e.g. painting robot) for coating components (e.g. motor vehicle body components) with at least one electrical consumer which requires electrical energy for operation. The disclosure provides a transmission system for wireless transmission of the electrical energy required for operation of the at least one consumer to the consumer and/or for transmission of data from and/or to the at least one consumer.

### CROSS-REFERENCE TO RELATED APPLICATIONS

This application is a national stage of, and claims priority to, Patent Cooperation Treaty Application No. PCT/EP2022/050842, filed on Jan. 17, 2022, which application claims priority to German Application No. 10 2021 101 026.8, filed on Jan. 19, 2021, which applications are hereby incorporated herein by reference in their entireties.

### FIELD

The disclosure relates to a coating device (e.g. painting robot) for coating components (e.g. motor vehicle body components).

### BACKGROUND

In modern painting systems for painting motor vehicle body components, rotary atomizers are usually used as application devices, which have an electrostatic coating agent charging system in order to achieve a high application efficiency so that as little overspray as possible is produced. During painting operation, the rotary atomizer is at a high-voltage potential so that the applied paint is charged to a high-voltage potential. There may be electrically operated consumers (e.g. sensors) in the rotary atomizer that must be supplied with power. However, a wired power supply to the consumers is problematic because the rotary atomizer and thus also the consumer to be supplied are at a high-voltage potential, which would require potential separation. In addition, electrical consumers can be arranged not only in the rotary atomizer, but also outside the rotary atomizer, e.g. on a robot arm of the painting robot, in a color changer or in a metering pump, in which case the power supply to the electrical consumers is also problematic, Usually, the electrical consumers in such cases are supplied with the power required for operation by batteries.

However, the power supply by batteries is associated with various disadvantages. For example, the batteries only have a relatively short service life, i.e. the batteries have to be replaced relatively fre-quently. This also leads to a relatively high consumption of resources, since new batteries are needed regularly and old batteries have to be disposed of. Finally, battery consumption is also associated with relatively high costs.

### BRIEF DESCRIPTION OF THE DRAWINGS

FIG. 1 shows a schematic representation of a coating device with a high-voltage zone and an electrically grounded zone and a wireless energy transmission between the two zones.

FIG. 2 shows the use of the transmission device according to FIG. 1 in a painting robot.

FIG. 3A shows a variation of FIG. 2, where the transmission device is arranged in the proximal robot arm (“Arm 1”).

FIG. 3B shows a schematic detail of the transmission device from FIG. 3A.

FIG. 4A shows a perspective view of a metering pump for a coating device with a pressure measurement module for pressure measurement.

FIG. 4B shows a perspective view of the pressure measurement module of the metering pump from FIG. 4A.

### DETAILED DESCRIPTION

The coating device according to the disclosure is used for coating components with a coating agent.

Preferably, this is a coating device for painting motor vehicle body components, i.e. the coating agent used is a paint and the painted components are motor vehicle body components.

However, with respect to the coating agent used, the disclosure is not limited to paints, but can also be realized with other types of coating agents, such as, for example, insulating materials, sealants, adhesives or the like.

Furthermore, the disclosure is not limited to motor vehicle body components with regard to the components to be coated, but is also suitable for coating other types of components, such as aircraft components.

First of all, in accordance with the prior art described above, the coating device according to the disclosure comprises at least one electrical consumer which requires electrical energy for operation. For example, the consumer may be an electrically operated sensor, but various other types of consumers are also possible, as will be described in detail.

The coating device according to the disclosure now differs from the prior art by a transmission system for wireless transmission of the electrical energy required for operation of the consumer to the consumer and/or for transmission of data from and/or to the at least one consumer.

Here, it should be mentioned that the transmission system may directly supply the electrical consumer (e.g., sensor) with the power required for operation. However, it is alternatively also possible that the transmission system supplies a buffer storage (e.g. accumulator) with current, whereby the electrical consumer then obtains the current required for operation from the consumer.

The transmission system according to the disclosure can thus fulfill different functions, namely on the one hand the transmission of energy and on the other hand the transmission of data. In the preferred embodiment of the disclosure, the transmission system fulfills both functions, i.e., on the one hand, the transmission system wirelessly transmits the electrical power required to operate the consumer to the consumer, and on the other hand, enables data transmission from the consumer and/or to the consumer. However, the disclosure also includes other variants of the disclosure in which the transmission system serves only for energy transmission or only for data transmission.

It was mentioned at the outset with respect to the prior art that the power supply of electrical consumers in a high-voltage zone is problematic. Therefore, the coating device according to the disclosure preferably has such a high-voltage zone which is under high voltage (e.g. more than 1 kV, 10 kV or 50 kV) during operation of the coating device and which contains, for example, an electrostatic coating agent charging system, as is known per se from the prior art. In addition, the coating device according to the disclosure preferably comprises an electrically grounded zone, as is also known per se from the prior art. In this case, the electrical consumer is arranged within the high-voltage zone and the transmission system transmits the electrical energy required to operate the consumer (e.g. sensor) from the electrically grounded zone to the high-voltage zone, in particular directly to the consumer. The wireless power transmission simultaneously separates the potential between the electrically grounded zone on the one hand and the high-voltage zone on the other.

However, the principle of a wireless transmission system according to the disclosure is not only suitable for supplying consumers in a high-voltage zone, but can also be used to supply consumers in an explosion-proof zone. For example, coating devices often comprises explosion-proof zones, which are usually designed as a closed space and can be purged with a gas, for example, to prevent the formation of an explosive gas mixture. The technical details of explosion-proof zones are laid down, for example, in the technical standard DIN EN 60079-2 and in the ATEX Directives 2014/34/EU, 1999/92/EC (ATEX: ATmospheres EXplosibles) of the European Union (EU). The term explosion-proof zone used in the context of the disclosure is therefore preferably to be understood in accordance with this technical standard or directive. In one variant of the disclosure, the coating device according to the disclosure can therefore have an explosion-proof zone which is preferably designed as a closed space within the coating device. In this case, the consumer is arranged within the explosion-proof zone and the transmission system transmits the electrical energy required to operate the consumer wirelessly from outside the explosion-proof zone into the explosion-proof zone, in particular directly to the consumer. For example, electrical consumers can be arranged in the distal robot arm (“arm 2”, “application arm”) of a painting robot, which are then located in an explosion-proof zone. The wireless transmission system can then transmit electrical power and/or data out of the explosion-proof zone and/or into the explosion-proof zone.

The disclosure thus comprises two different variants, namely one for supplying an electrical consumer in a high-voltage zone and the other for supplying a consumer in an explosion-proof zone. These two variants can also be combined within the scope of the disclosure. For example, the high-voltage zone may be at least partially an explosion-proof zone in which the consumer is arranged, which is supplied wirelessly by the transmission system with the electrical energy required for operation. However, it is alternatively possible that the high-voltage zone is not explosion-proof or that the explosion-proof zone does not have a high-voltage zone. Even in these alternatively possible cases, the disclosure offers significant advantages.

It has already been mentioned above that the transmission system operates wirelessly. For example, this can be done in the context of inductive coupling, resonant-inductive coupling or capacitive coupling. However, the disclosure is not limited to these types of coupling with respect to the wireless transmission types. For example, optical coupling is also possible, which can be implemented by optocouplers.

In the case of inductive coupling, the transmission system typically comprises a transmitting coil and a receiving coil, which are inductively coupled to one another and thus enable energy to be transferred from the transmitting coil to the receiving coil. The transmitting coil is arranged in the electrically grounded zone or outside the explosion-proof zone. The receiving coil, on the other hand, is arranged in the high-voltage zone or in the explosion-proof zone. Between the transmitting coil and the receiving coil there is preferably a high-voltage proof insulating section for electrically insulating the transmitting coil from the receiving coil, so that the transmitting coil can be at ground potential while the receiving coil can be at high-voltage potential.

In addition, the transmission system here preferably comprises an oscillator which is connected to the transmitting coil and is also arranged in the electrically grounded zone or outside the explosion-proof zone. The oscillator controls the transmitting coil with an alternating voltage signal, which can have a frequency of 10 kHz to the MHz range, for example. Ranges (i.e. distance between the transmitting coil and the receiving coil) are possible, from a few centimeters for inductive coupling to several meters for resonant-inductive coupling.

Furthermore, the coating device according to the disclosure preferably comprises a rectifier which is connected to the receiving coil and is arranged in the high-voltage zone or in the explosion-proof zone. The rectifier receives the AC signal generated by the receiving coil and generates therefrom a DC signal for supplying power to the consumer.

It has already been mentioned above that the transmission system can transmit not only power but also data. Here, it should first be mentioned that the data transmission can be unidirectional or bidirectional. In the case of unidirectional data transmission, there are two possibilities. One possibility is that the data is only transmitted in the direction of the consumer. Another option is to transmit the data only from the consumer, for example to a central evaluation unit.

With regard to the data to be transmitted, various possibilities exist within the scope of the disclosure. For example, firmware can be transmitted that is installed on the consumer. In this way, the firmware installed on the consumer can be easily updated.

Furthermore, it is possible for the data to be process data generated by at least one sensor and reflecting the current state of a process of at least a part of the coating device. For example, the sensor may be a pressure sensor, but other types of sensors are also possible, as will be described in detail. The transmitted process data can therefore be, for example, pressure values (e.g. paint pressure, shaping air pressure, drive air pressure, brake air pressure), flow rate values (e.g. paint flow, shaping air flow, drive air flow, brake air flow), voltage values (e.g. charging voltage of an electrostatic coating agent charge) or current values (e.g. charging current of an electrostatic coating agent charge).

Further, the transmitted data may be a product identification identifier that identifies at least one component of the coating device. The transmission device can then read out the product identification code and thus, for example, detect plagiarisms or components requiring maintenance.

In addition, the data to be transmitted can also be configuration data or parametric data.

In a preferred embodiment of the disclosure, the coating device is a coating robot. Such coating robots are known per se from the prior art and therefore need not be described in detail. However, it should be mentioned here that such coating robots can have at least one robot arm, with typical coating robots having a proximal robot arm (“Arm 1”) and a distal robot arm (“Arm 2”). The distal robot arm can be pivoted relative to the proximal robot arm and usually carries a multi-axis robot hand axis at its end, whereby an application device (e.g. rotary atomizer or print head) can be mounted on the robot hand axis.

The high-voltage zone or the explosion-proof zone is preferably located in one of the robot arms (e.g. “Arm 2”).

The electrically grounded zone is then preferably located in the same robot arm (e.g. “Arm 2”) as the high-voltage zone.

The high-voltage zone is separated from the electrically grounded zone in the robot arm (e.g. “Arm 2”) by an insulating section (e.g. partition wall made of plastic).

The transmitting coil and the receiving coil can then also be arranged in the robot arm (e.g. “Arm 2”.

Furthermore, the electrical consumer may also be arranged in the same robot arm (e.g., “Arm 2”), which may be, for example, a sensor collection device that collects measurement signals from a plurality of sensors, the sensor collection device preferably being arranged in the distal robot arm.

Furthermore, the coating device can also have a high-voltage cascade for electrostatic coating agent charging, which is then preferably arranged in the proximal robot arm.

Two possible installation examples for a coating robot are now described below.

In a first installation example, the distal robot arm (“Arm 2”) contains the essential components, namely the transmitting coil, the receiving coil, the insulating section and the consumer.

In another embodiment, however, the essential components are located in the proximal robot arm (“Arm 1”), namely the transmitting coil, the receiving coil, the insulating section and the high-voltage cascade.

The aforementioned sensor can, for example, be a pressure sensor, in particular on a metering pump that meters the coating agent. In this case, two pressure sensors can also be provided, which measure the coating agent pressure upstream of the metering pump and downstream of the metering pump. Alternatively, a flow sensor, a speed sensor, a force sensor, an acceleration sensor, a vibration sensor or a temperature sensor can be used, to name just a few examples.

Furthermore, the electrical consumer may be an electrically actuated valve, such as a shaping air valve, a coating agent valve, a drive air valve of a pneumatically driven rotary atomizer or a brake air valve of a pneumatically driven rotary atomizer.

Furthermore, it is possible that the consumer is a transmitter for sending data or a receiver for receiving data.

However, the disclosure is not limited to the above examples with respect to the type of electrically driven consumer.

Furthermore, it should be mentioned that the coating device according to the disclosure may also comprise another manipulator instead of or in addition to a coating robot, e.g. a surface machine, a surface automat or a multi-axis gantry.

Furthermore, it should be mentioned in general that the electrical consumer may be located in close proximity to the receiving unit (e.g., receiving coil) of the wireless transmission system. However, it is alternatively possible that the electrical consumer is spatially separated from the receiving unit (e.g. receiving coil) of the wireless transmission system, in which case a connecting line connects the electrical consumer to the receiving unit (e.g. receiving coil) of the wireless transmission system.

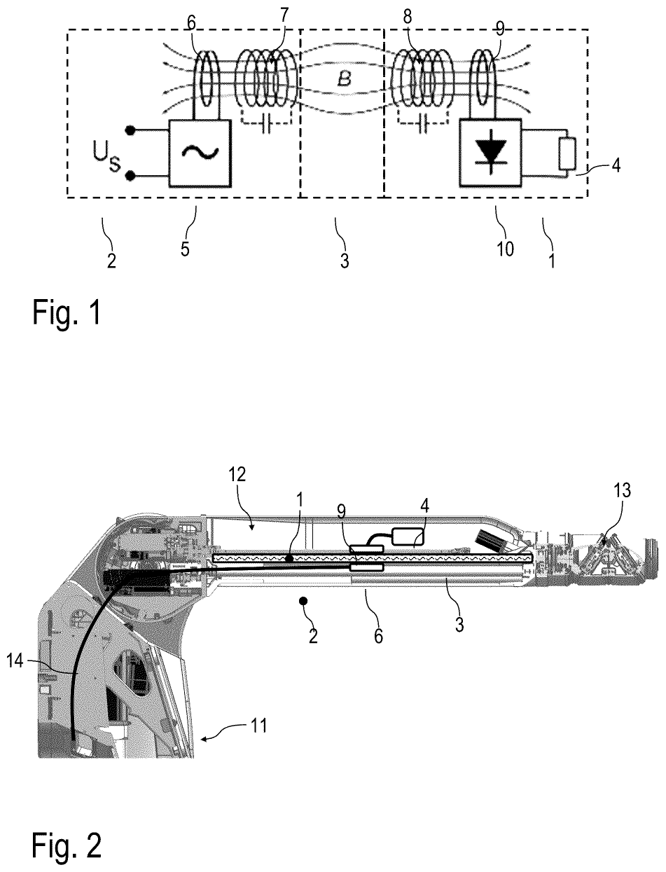

A schematic representation of a coating device according to the disclosure as shown in FIG. 1 is described herein. For example, this can be a painting robot for painting motor vehicle body components, which comprises a rotary atomizer with an electrostatic coating agent charge as an application device.

The coating device comprises a high-voltage zone 1 which, in operation, is at a high-voltage potential of several 10 kV due to the electrostatic coating agent charging.

Furthermore, the coating device comprises an electrically grounded zone 2, which is at ground potential during operation.

An insulating section 3 is located between the grounded zone 2 and the high-voltage zone 1, which isolates the high-voltage zone 1 from the electrically grounded zone 2.

An electrical consumer 4 is located in the high-voltage zone 1, which may be an electrically operated pressure sensor, for example.

An oscillator 5 is located in the grounded zone 2, which drives a transmitting coil 6 with a high-frequency signal, whereby the transmitting coil 6 excites a resonant circuit 7 in the electrically grounded zone 2.

In the high-voltage zone 1 there is a correspondingly tuned further resonance circuit 8, which is arranged next to a receiving coil 9.

In this case, the receiving coil 9 is resonantly-inductively coupled to the transmitting coil 6 via the resonant circuits 7, 8. This means that the oscillator 5 generates high-frequency energy which reaches the receiving coil 9 via the inductive coupling and is rectified there by a rectifier 10. The rectifier 10 then supplies the consumer 4 with the electrical energy required for operation.

It should be mentioned here that the high-voltage zone 1 is also an explosion-proof zone in accordance with the technical standard DIN EN 60079-2. The constructional details of such explosion-proof zones are in themselves known from the prior art and therefore need not be described in detail. Energy transmission by inductive coupling also offers the advantage here that explosion protection in the high-voltage zone 1 is not impaired by the energy transmission.

FIG. 2 shows an installation example of the coating device according to the disclosure as shown in FIG. 1 in a painting robot for painting motor vehicle body components. To avoid repetition, reference is made here to the above description of FIG. 1, where the same reference signs are used for corresponding details.

The painting robot initially comprises a proximal robot arm 11 (“Arm 1”) and a distal robot arm 12 (“Arm 2”), the distal robot arm 12 being pivotable relative to the proximal robot arm 11.

Mounted at the end of the distal robot arm 12 is a multi-axis robot hand axis 13 which, in use, carries the application device, such as a rotary atomizer or a print head.

The high-voltage zone 1 and the grounded zone 2 are located here within the distal robot arm 12, with the insulating section 3 extending along the distal robot arm 12 as a partition wall made of an electrically insulating material (e.g. plastic) between the high-voltage zone 1 and the grounded zone 2.

Furthermore, the electrical consumer 4 (e.g. sensor, sensor collection box) is also located in the high-voltage zone 1 in the distal robot arm 12.

Furthermore, the drawing shows a supply line 14 leading to the oscillator 5, which is not shown here.

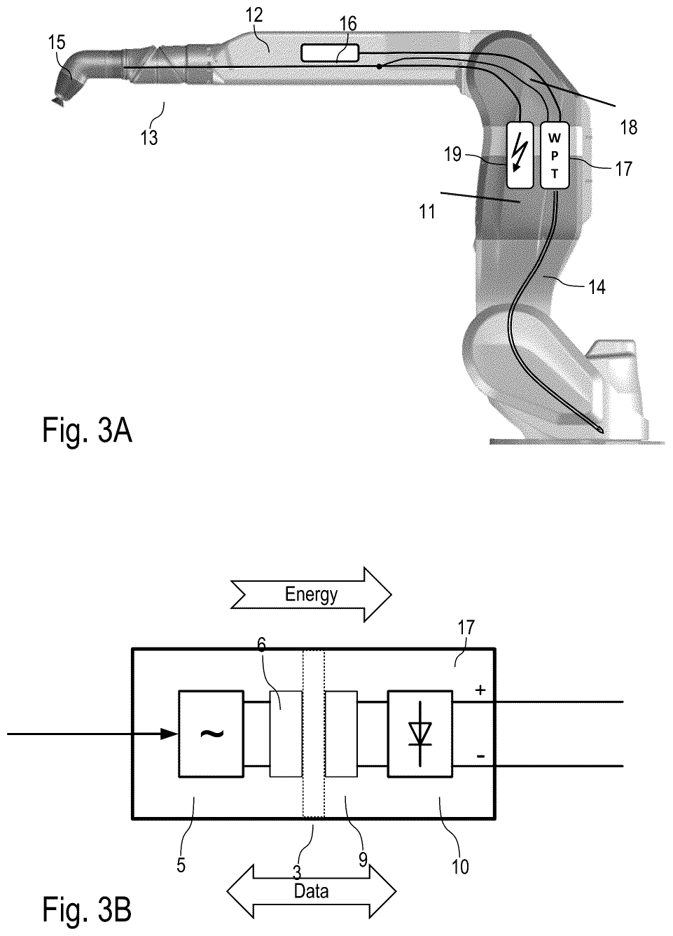

FIGS. 3A and 3B show another embodiment in a painting robot, again referring to the above description to avoid repetition, using the same reference signs for corresponding details.

FIG. 3A also shows that a rotary atomizer 15 is mounted on the robot hand axis 13.

Furthermore, a sensor collection box 16 is arranged in the distal robot arm 12, which is connected to several sensors in the painting robot, whereby the sensors are not shown for simplification.

The actual transmission system 17 is located in the proximal robot arm 11, which is designed as a unit that is shown in FIG. 3B and will be described later.

Furthermore, FIG. 3A shows a swivel joint 18 between the proximal robot arm 11 and the distal robot arm 12.

Furthermore, it can be seen that a high-voltage cascade 19 is arranged in the proximal robot arm 11, which is used for electrostatic coating agent charging.

FIG. 3B shows the structure of the transmission system 17, which functions largely in accordance with the structure shown in FIG. 1, so that reference is made to the above description of FIG. 1 in order to avoid repetition.

However, it can be seen from FIG. 3B that the transmission system 17 not only enables power transmission, but also bidirectional data transmission, as indicated by the double arrow at the bottom. For this purpose, the inductively transmitted signals can be modulated, for example, as is known per se from the prior art.

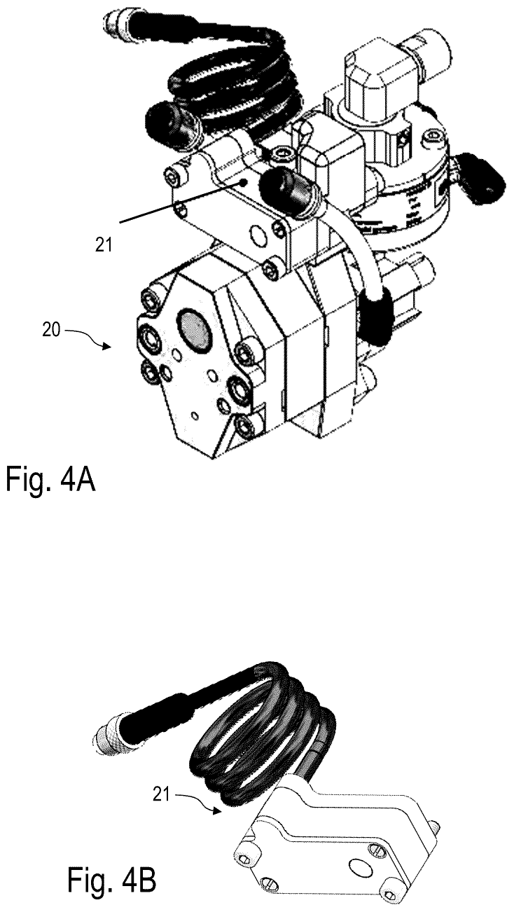

Finally, FIGS. 4A and 4B show different perspective views of a metering pump 20 with a pressure measurement module 21, wherein the metering pump 20 can be used for metering paint for a painting robot and can be located, for example, in a high-voltage zone. The pressure measurement module 21 can then measure the coating medium pressure upstream of the metering pump 20 and downstream behind the metering pump by means of pressure sensors, the pressure sensors being electrically operated and supplied with the electrical energy required for operation by the transmission system according to the disclosure. In addition, the data retrieval from the pressure measurement module 21 is also carried out with the transmission system according to the disclosure.

The disclosure is not limited to the preferred embodiments described above. Rather, a large number of variants and variations are possible which also make use of the idea of the disclosure and therefore fall within the scope of protection. In particular, the disclosure also claims protection for the subject matter and the features of the dependent claims independently of the claims referred to in each case and in particular also without the features of the main claim. The disclosure thus comprises different aspects of the disclosure which enjoy protection independently of each other.

1.-12. (canceled)

13. A coating device for coating components, comprising:
a) at least one electrical consumer which requires electrical energy for operation,
b) a transmission system for wireless transmission of the electrical energy required for operation of the at least one consumer to the consumer and/or for transmission of data from and/or to the at least one consumer.

14. The coating device according to claim 13, wherein
a) the coating device comprises an electrically grounded zone,
b) the coating device comprises a high-voltage zone which is under high voltage during operation of the coating device,
c) the consumer is arranged within the high-voltage zone, and
d) the transmission system transmits the electrical energy required to operate the consumer from the electrically grounded zone into the high-voltage zone.

15. The coating device according to claim 14, wherein, the transmission system transmits the electrical energy required to operate the consumer directly to the consumer.

16. The coating device according to claim 13, wherein
a) the coating device comprises an explosion-proof zone,
b) the consumer (4) is arranged within the explosion-proof zone (1), and
c) the transmission system transmits the electrical energy required to operate the consumer from outside the explosion-proof zone into the explosion-proof zone.

17. The coating device according to claim 16, wherein the explosion-proof zone is an enclosed space within the coating device.

18. The coating device according to claim 16, wherein the transmission system transmits the electrical energy required to operate the consumer directly to the consumer.

19. The coating device according to claim 13, wherein the transmission system operates with one of the following couplings:
a) inductive coupling,
b) resonant-inductive coupling,
c) capacitive coupling,
d) optical coupling.

20. The coating device according to claim 14, wherein the transmission system comprises:
a) a transmitting coil arranged in the electrically grounded zone,
b) a receiving coil arranged in the high-voltage zone.

21. The coating device according to claim 16, wherein the transmission system comprises:
a) a transmitting coil arranged outside the explosion-proof zone,
b) a receiving coil arranged in the explosion-proof zone.

22. The coating device according to claim 20, wherein a high-voltage proof insulating section is arranged between the transmitting coil and the receiving coil for electrically insulating the transmitting coil from the receiving coil.

23. The coating device according to claim 20, wherein the transmission system comprises:
a) an oscillator connected to the transmitting coil and arranged in the electrically grounded zone, and
b) a rectifier which is connected to the receiving coil and is arranged in the high-voltage zone.

24. The coating device according to claim 21, wherein the transmission system comprises:
a) an oscillator connected to the transmitting coil and arranged outside the explosion-proof zone, and
b) a rectifier which is connected to the receiving coil and is arranged in the explosion-proof zone.

25. The coating device according to claim 13, wherein the transmission system is set up both for wireless transmission of the electrical energy required for operating the consumer and for transmission of data from and/or to the consumer.

26. The coating device according to claim 13, wherein the transmitted data comprises the following data:
a) firmware installed on the consumer,
b) process data generated by at least one sensor and reflecting the current state of a process of at least a part of the coating device,
c) a product identification code which identifies at least one component of the coating device, and
d) configuration data or parameterization data.

27. The coating device according to claim 13, wherein
a) the coating device comprises a coating robot with at least one robot arm, and
b) the high-voltage zone is arranged at least partially in the robot arm, and
c) the electrically grounded zone is arranged at least partially in the robot arm, and
d) the insulating section separates the electrically grounded zone from the high-voltage zone and is arranged in the robot arm.

28. The coating device according to claim 27, wherein
a) the transmitting coil and the receiving coil are arranged in the robot arm, and
b) the consumer is arranged in the robot arm.

29. The coating device according to claim 13, wherein the consumer is a sensor collecting device which collects measurement signals from a plurality of sensors.

30. The coating device according to claim 13, wherein the coating device for electrostatic coating agent charging comprises a high-voltage cascade.

31. The coating device according to claim 27, wherein the robot comprises a proximal robot arm, a distal robot arm and a robot hand axis.

32. The coating device according to claim 31, wherein the following components are arranged in the distal robot arm, which is kinematically arranged between the proximal robot arm and the robot hand axis:
a) the transmitting coil,
b) the receiving coil,
c) the insulating section and
d) the consumer.

33. The coating device according to claim 31, wherein the following components are arranged in the proximal robot arm, which is kinematically arranged in front of the distal robot arm:
a) the transmitting coil,
b) the receiving coil,
c) the insulating section and
d) the high-voltage cascade.

34. The coating device according to claim 13, wherein the coating device comprises one of the following manipulators to move an applicator:
a) surface machine,
b) surface automat,
c) multi-axis gantry.

35. The coating device according to claim 13, further comprising the following consumers:
a) sensor,
b) electrically actuated valve,
c) transmitter for sending data, and
d) receiver for receiving data.

36. The coating device according to claim 33, wherein the sensor is selected from a group consisting of:
a) pressure sensor, in particular on a metering pump which meters the coating agent,
b) flow sensor,
c) speed sensor,
d) force sensor,
e) acceleration sensor,
f) vibration sensor,
g) temperature sensor.
